(19) United States
(12) Patent Application Publication
(10) Pub. No.: US 2026/0095840 A1
(43) Pub. Date: Apr. 2, 2026

(54) DATA SOURCE MANAGEMENT OF A ROUTER

(71) Applicant: Connectify, Inc., Philadelphia, PA (US)

(72) Inventors: Alexander Gizis, Philadelphia, PA (US); Brian Prodoehl, Plymouth Meeting, PA (US); Kevin Cunningham, Swarthmore, PA (US)

(21) Appl. No.: 19/341,920

(22) Filed: Sep. 26, 2025

Related U.S. Application Data
(60) Provisional application No. 63/700,591, filed on Sep. 27, 2024.

(51) Int. Cl. H04W 40/12; H04L 45/28

(52) U.S. Cl. CPC H04W 40/12; H04L 45/28

(57) ABSTRACT

One example may include forwarding data, via a router operating on a local data network, to a first client device, determining, via the router, a failure in a data connection used to receive the data from another data network, identifying, via the router, a second client device operating on the local data network, transmitting, via the router, a message over the local data network to the second client device, responsive to the message being received by the second client device, receiving, via the router, additional data over the local data network from the second client device, and forwarding, via the router, the additional data to the first client device.

### TECHNICAL FIELD

This application relates to data management and more particularly to a router managing data distribution by multiple data sources.

### BACKGROUND

Client devices may be identified as being at a particular source and location and having specific attributes, such as a hardware device profile, an assigned IP address, an assigned network, etc. The use of client devices to perform various data access operations can be prohibited or at least limited by the settings and restrictions of the remote data sources that are being accessed by the client devices. For example, a client device may be attempting to access a secure and popular server for secure information, such as streaming content, secure order information, access to a protected account, etc.

A virtual private network (VPN) server is a tool that can offer an alternative to a client device’s normal network data traffic. Generally, a VPN server may use different network routes and perform encryption among other data management operations. When client devices desire to share data and related services with other client devices, the VPN server may provide a way to connect to the Internet and remote servers to download data and forward the data to one or more requesting client devices. One or more client devices may provide data sharing with one or more other client devices by receiving the shared data through the VPN server.

Aside from the VPN server, a local router has access to a local network that provides data services to various client devices connected to the local network. In the event of a data failure from a data source, such as an Internet service provider (ISP), the router is in a position to offer one or more client devices access to other data sources, such as the cellular data available to the one or more client devices. One client device may receive the benefit of its own cellular data while simultaneously using the cellular data of another or multiple other client devices. The router also provides a source of multiple data streams which can be combined into a bonded and/or mirrored data stream of multiple channels for additional data services to the client devices operating on the network.

### SUMMARY

One example embodiment may include a network configuration where a router can provide data management among client devices from an ISP or from other data sources available to the client devices.

An example embodiment may include a process including forwarding data, via a router operating on a local data network, to a first client device, determining, via the router, a failure in a data connection used to receive the data from another data network, identifying, via the router, a second client device operating on the local data network, transmitting, via the router, a message over the local data network to the second client device, responsive to the message being received by the second client device, receiving, via the router, additional data over the local data network from the second client device, and forwarding, via the router, the additional data to the first client device.

### BRIEF DESCRIPTION OF THE DRAWINGS

FIG. 1 illustrates a communication network used to support data management of client devices according to example embodiments.

FIG. 2A illustrates an example of client devices receiving data from a router and their respective cellular access networks according to example embodiments.

FIG. 2B illustrates an example of client devices communicating with the router with an inactive Internet connection and their respective cellular access networks according to example embodiments.

FIG. 2C illustrates an example of client devices communicating with the router with an inactive Internet connection and sharing their respective cellular access with the router according to example embodiments.

FIG. 2D illustrates an example of client devices communicating with the router with an Internet connection and sharing their respective cellular access with the router so a client device can receive data from shared cellular data and from an Internet connection associated with the router according to example embodiments.

FIG. 2E illustrates an example of client devices communicating with the router with an Internet connection and sharing their respective cellular access with the router so a machine learning application can be used to determine the most optimal connection to use for a client device to receive data from shared cellular data and/or from an Internet connection associated with the router according to example embodiments.

FIG. 3A is a process of a router managing multiple data sources for multiple client devices according to example embodiments.

FIG. 3B is a process of a client device initiating a data sharing operation with other available client devices according to example embodiments.

FIG. 4A illustrates an example user interface of a client device initiating a data sharing operation with other devices available on a common network according to example embodiments.

FIG. 4B illustrates an example user interface of a client device customizing a data sharing application with other devices available on a common network according to example embodiments.

FIG. 5 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments provide data management services for client devices participating in a shared data network configuration. Data may be sent and received to and from a remote network and shared between the devices to provide a larger data rate and an optimized data connection.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/ Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

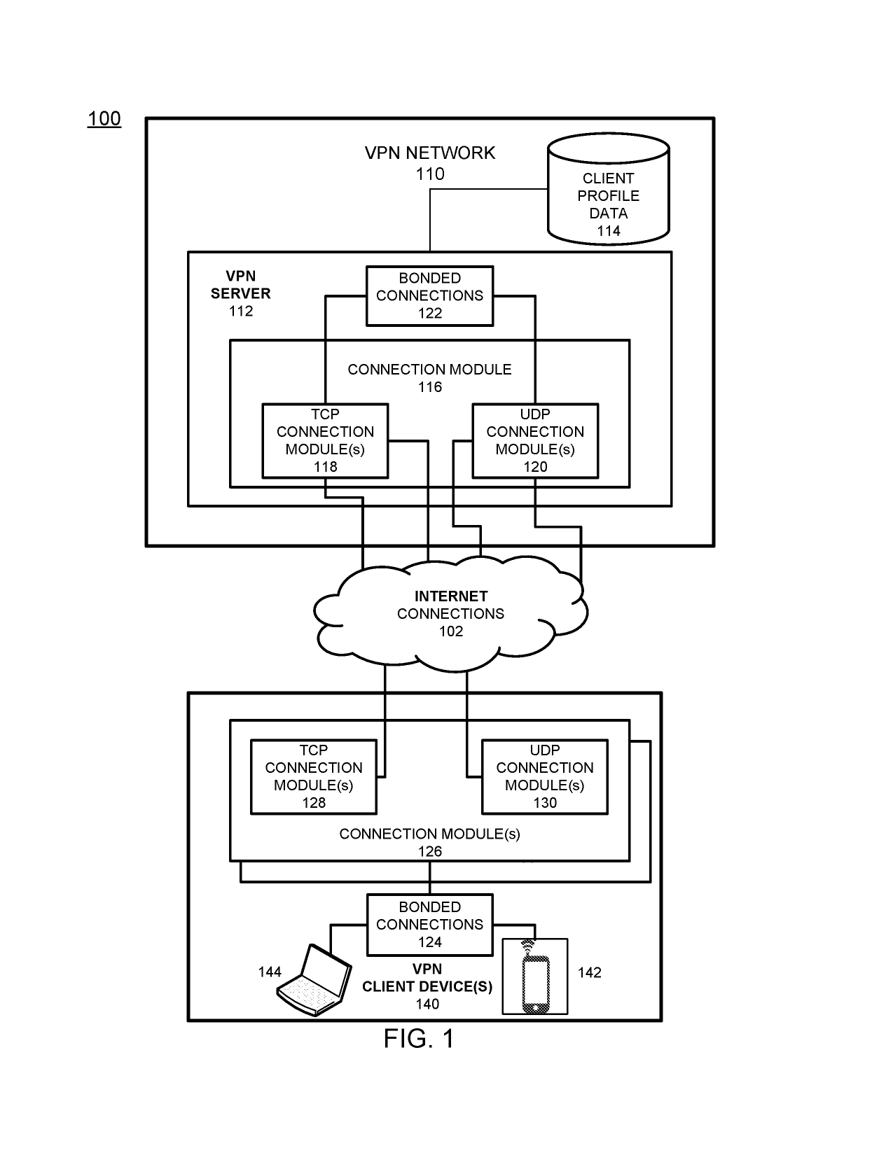

FIG. 1 illustrates an example data session network configuration according to example embodiments. Referring to FIG. 1, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transport connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

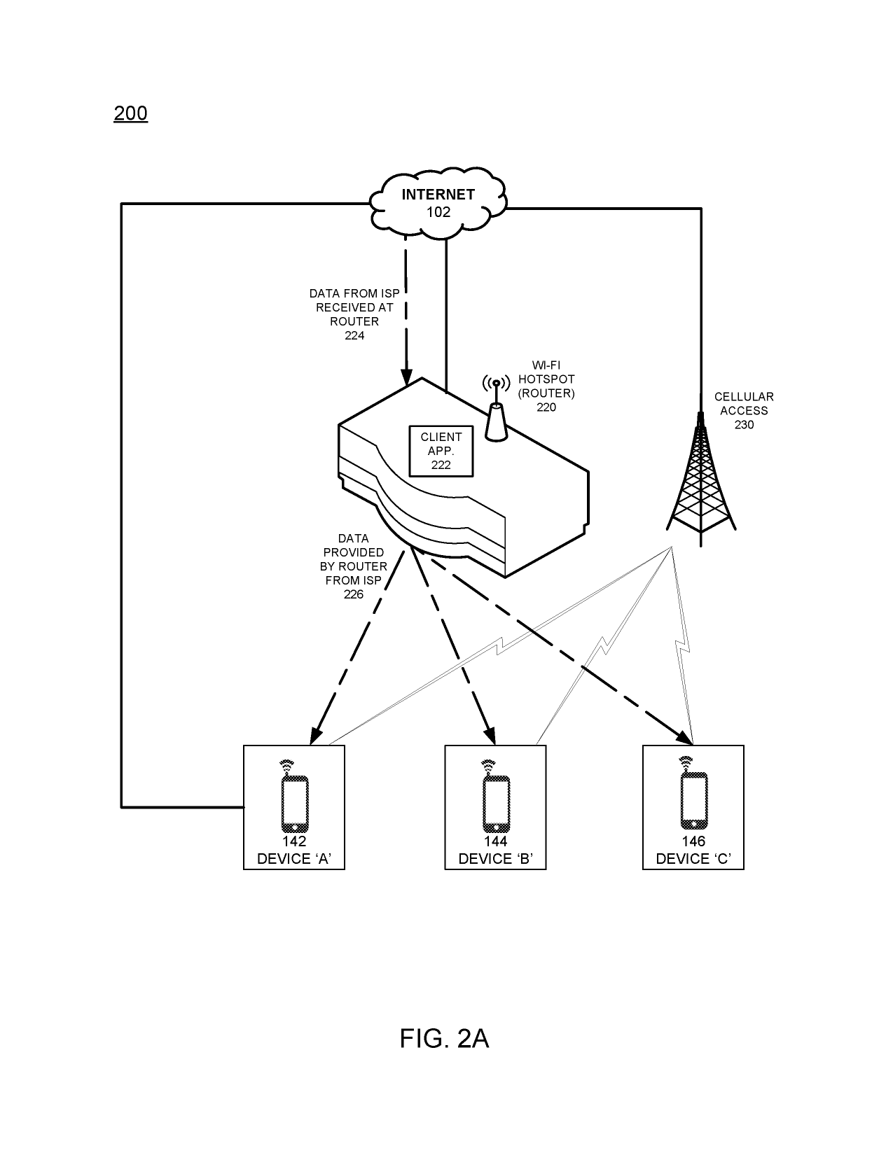

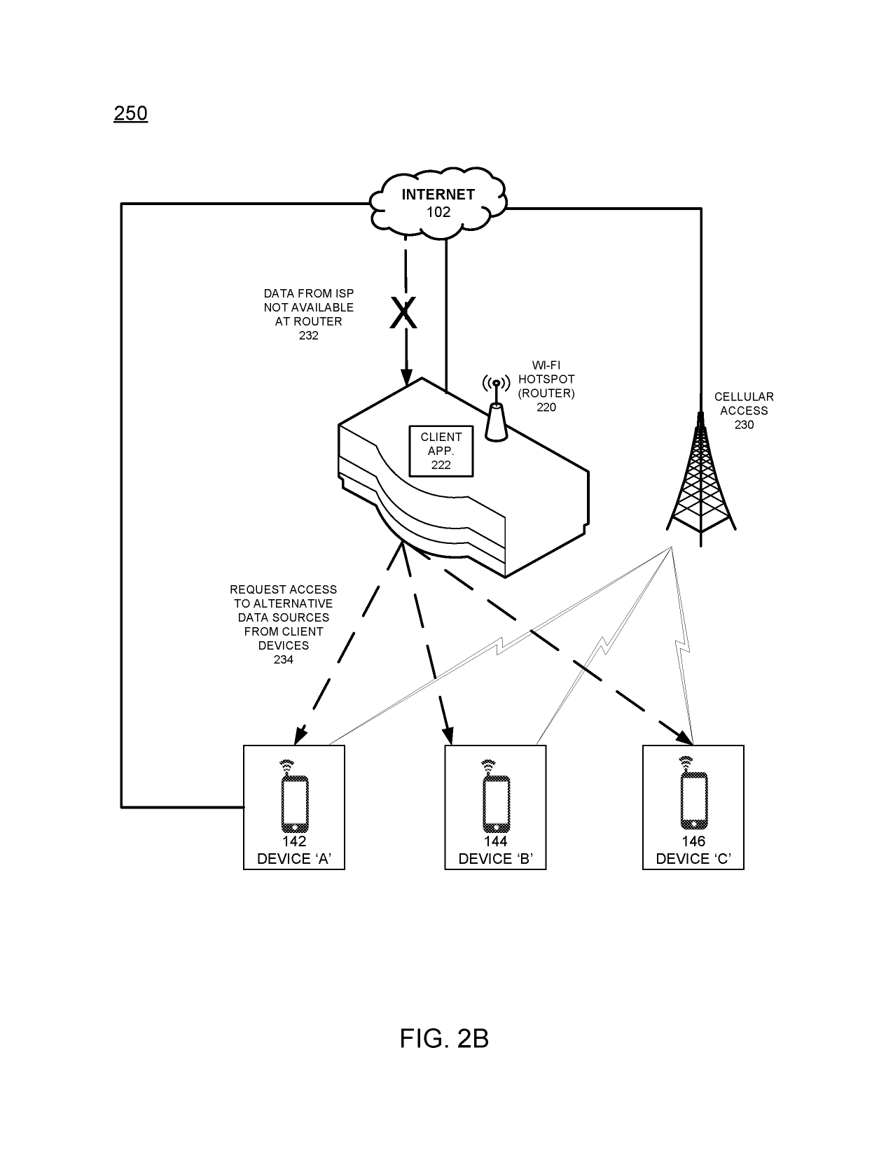

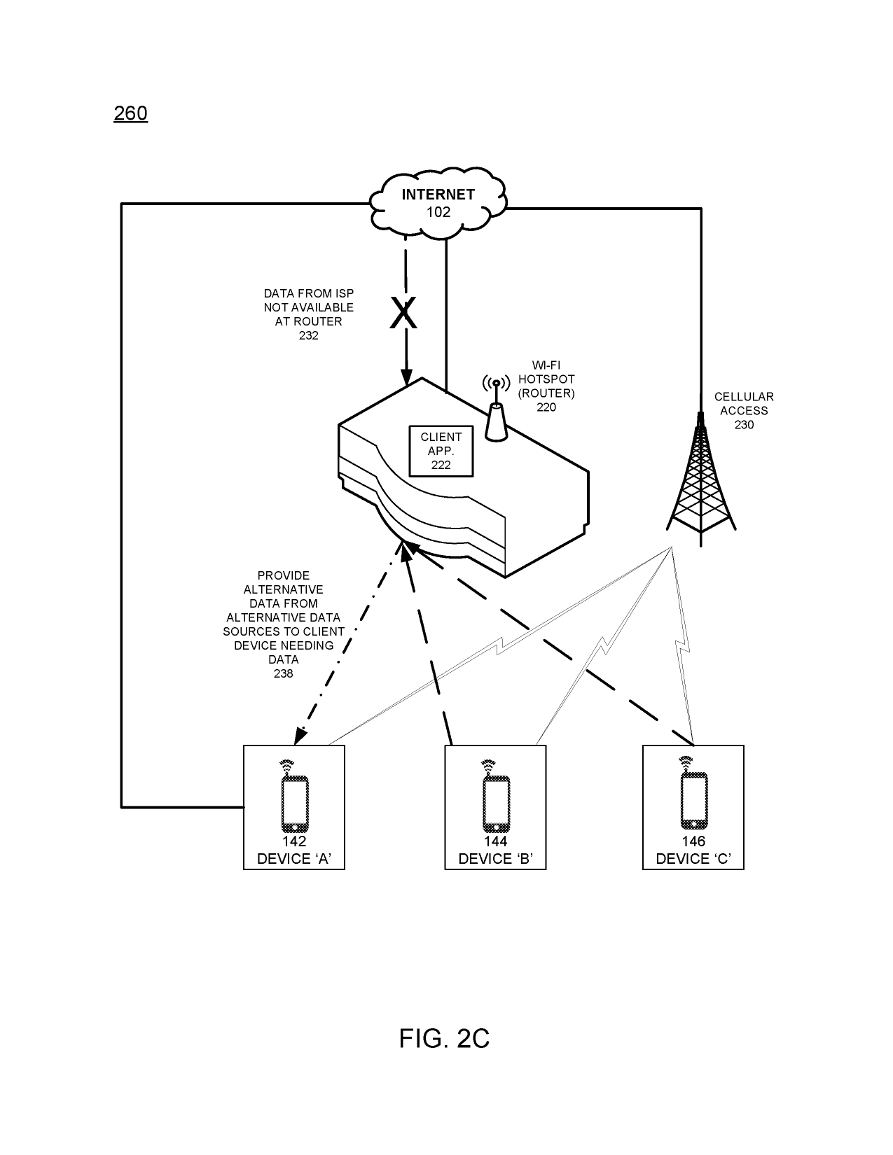

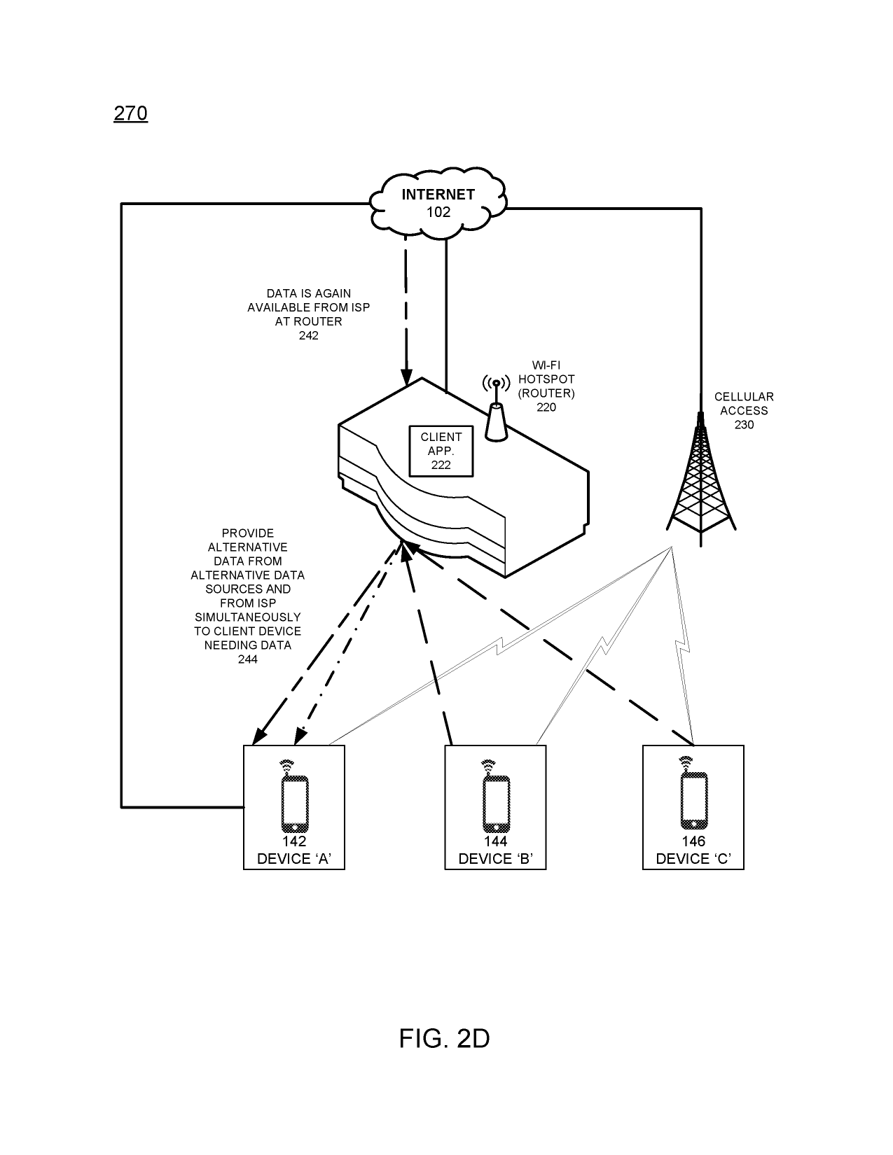

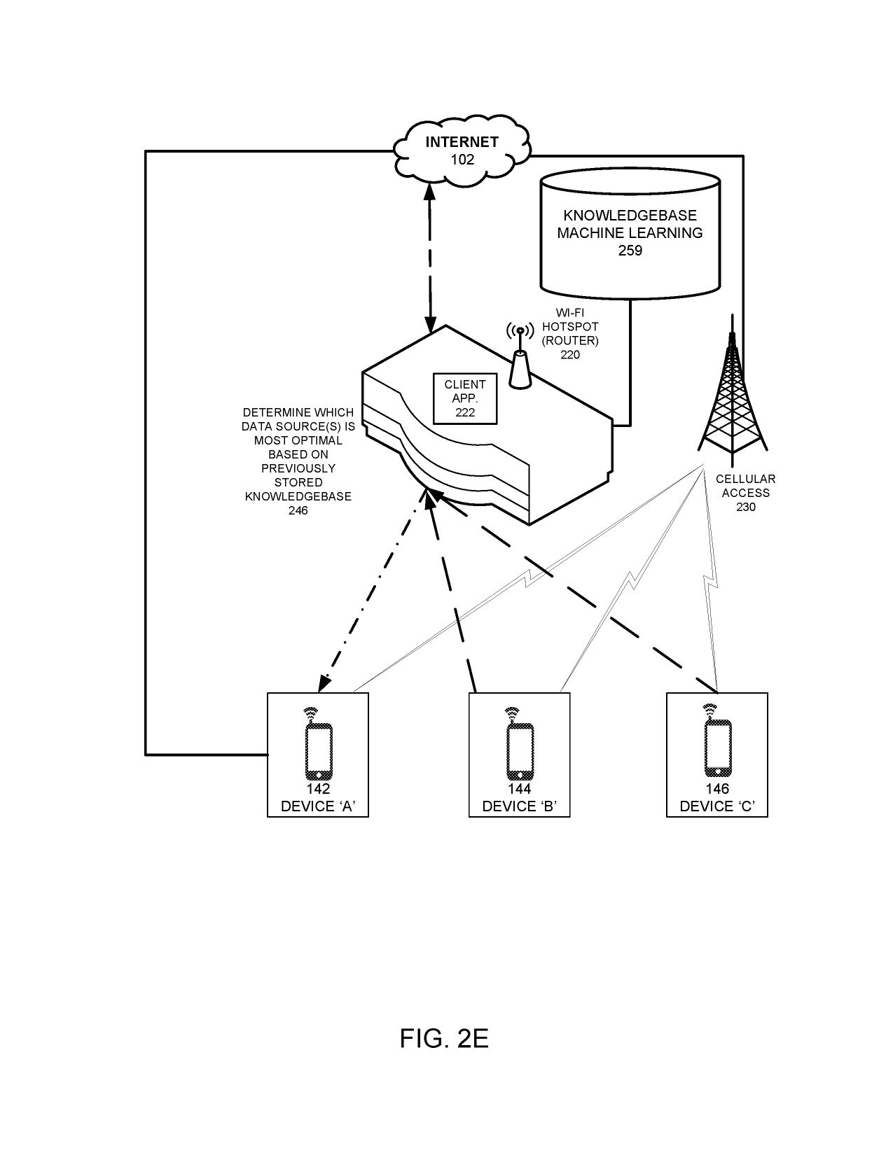

FIG. 2A illustrates an example network 200 of client devices receiving data from a router and their respective cellular access networks according to example embodiments. Referring to FIG. 2A, a data router 220 may be routing data to one or more client devices 142-146 as part of a local network. The connections may be wired and/or wireless. A first client device ‘A’ 142 may transmit and receive data to and from the router. Other client devices ‘B’ 144 and ‘C’ 146 may also transmit and receive data to and from the router 220. The client devices may have additional data sources other than the router 220, such as a wireless data channel provided by one or more respective cellular communication networks 230. The client devices may be receiving data from a cellular communication access point 230, as a common cellular access point or alternative cellular networks, and forwarding the data to the router 220 in instances where one client device is sharing its cellular data with another client device via the router 220 as a sharing access point. The router 220 generally uses a cable/fiber connection to connect to an Internet service provider which provides a data connection 224 to the Internet, which can be shared over communication channels 226 with the client devices. The data received from an ISP 224 may be shared 226 with any and all client devices subscribed to the router’s communication network. A client application 222 operating on the router may be installed to manage the various client devices and their respective data services. The application may assign, monitor and modify data channels for any and all client devices 142-146.

FIG. 2B illustrates an example network configuration 250 of client devices communicating with the router with an inactive Internet connection and active respective cellular access according to example embodiments. Referring to FIG. 2B, when the ISP connection fails 232, the router 220 may use a client application 222 configured to communicate and offer alternative data sources to the client devices in a seamless and autonomous manner. In operation, when the router 220 detects a loss of data 232 from the ISP, the router may attempt to communicate with the client devices and notify the devices about alternative data sources, or, alternatively, modify the data sources seamlessly without any additional communications. A client device which is currently using data services above a threshold data usage amount, such as when using a streaming data service or a large data file download, etc., the router 220 may receive data from any participating client devices setup to share data and provide that data as an alternative form of data to any one or more of the connected client devices 142-146.

When the router 220 cannot establish an active communication path with the ISP and/or the amount of data received over a predefined period of time is below a data threshold, the router 220 may attempt to solicit/request 234 data from one or more of the client devices 142-146. The router 220 may initially attempt to determine which client devices are in a sharing mode of operation, based on a setting initiated by the client devices and stored in the client application 222 of the router 220. A notification may be sent from the router 220 to each client device 142-146 to share the current network status. The notification may include a request to begin forwarding cellular data received by each of the client devices to the router 220 based on one or more instructions by the router 220.

FIG. 2C illustrates an example 260 of client devices communicating with the router with an inactive Internet connection and sharing their respective cellular access with the router according to example embodiments. Referring to FIG. 2C, the client devices may communicate directly with the router 220 or via direct communication channels between the devices, such as via a point to point or peer to peer (P2P) connection, a BLUETOOTH, and/or Wi-Fi communication protocol, etc. Other communication protocols are contemplated, such as UWB, NFC, Li-Fi.

In one example, device 142 is communicating with a Wi-Fi network provided by the router 220 and a cellular network 230. Device 144 is also using the same Wi-Fi network and a same or different cellular data service 230. In this example, the client device 142 is identified as needing data at that moment to perform a data consuming task, such as receiving streaming data from a remote server. The client device 144 may receive an instruction to use its cellular data to connect to the same remote server and provide the downloaded data to the router 220 which forwards the data to the consuming device 142. The data from the cellular network 230 may be received by the client device 142 directly via its own cellular connection and the additional data received by the client device 142 from the router 220 may be received from the client device 144 and that data may be bonded together with the original cellular data as two or more data channels by the router 220.

The channel bonding application applied by the router 220 enables some data packets of a packet stream to be sent via a first channel and other data packets to be sent via a second channel. In this case, some packets are received by the cellular data connection 230 at the client device 142 and forwarded to the router 220, where the application 222 bonds the packets from the different channels and performs a packet forwarding operation to send the combined data to the client device 142. Each packet may be unique on each channel so the bonded channels can be used to provide more packets faster to the intended recipient client device 142.

The router 220 may identify data needs of each client device based on current and upcoming data usage requests received. One or more of the client devices may have unlimited access, or alternatively, limited access available for other client devices to use shared data. The restrictions on data usage may be stored in the client application 222 of the router 220. In the example of FIG. 2C, the data provided to the client device 142 may be its own cellular data in combination with cellular data of client devices 144 and/or 146, which would be sent directly from one device to another device without the router 220 and/or the data may be sent across the local data network managed by the router 220 where the router 220 can forward the data to the intended end user device.

Device 142 may be streaming data from a remote server and/or performing other data intensive operations and may be attempting to identify all possible data channels available. In one example when devices 144/146 confirm requests received and agree to provide data sharing services by transmitting a response message directly to device 142 via a device-to-device communication protocol or via a response to the router 220, then device 144 can receive instructions to transmit data to and from the router 220 over the Wi-Fi network based on its use of the cellular network 230. The router 220 or the recipient device 142 can then bond the channels used, such as one channel from device 144, on behalf of device 142, over the Wi-Fi network, with other channels used by device 142, such as a channel of its own cellular network access 230. Additional channels can be provided, such as a channel from device 146 and/or data available from the ISP when the ISP is identified as being active again. That scenario provides that there may be one to four channels used at any given time assuming one channel per data service. However, any number of channels may be available to provide data services from any one service.

The device 142 may simultaneously receive data packets from its cellular connection while receiving data packets from device 144 forwarded from the router 220. The packets may be unique and may be combined into a single data stream, such as for streaming data or other large data accumulations. When device 144 and/or 146 approve the data sharing request or is configured to participate in data sharing, then the router 220 may transmit an instruction message that identifies itself as a destination to receive and forward data requests to and from device 142.

FIG. 2D illustrates an example of client devices communicating with the router with an Internet connection and sharing their respective cellular access with the router according to example embodiments. Referring to FIG. 2D, the example configuration 270 may include the router 220 re-establishing a connection 242 with the ISP and still providing data to a client device, such as 142 from the ISP and from other client devices and their respective cellular connections.

FIG. 2E illustrates an example of client devices communicating with the router with an Internet connection and sharing their respective cellular access with the router so a machine learning application can be used to determine the most optimal connection to use for a client device to receive data from shared cellular data and/or from an Internet connection associated with the router according to example embodiments. Referring to FIG. 2E, the example provides that a client device 142 may need data services to access one or more remote servers. The application used by the client device along with other information, such as the client device hardware, a time of day, time of week, an address of the remote server, available data channels, etc. The machine learning database 259 may store all the information necessary to determine whether to use one or more of the available data sources. The previously stored information 246 may be used to select which of the one or more data sources to use to enable a current data usage scenario.

An information set of known data parameters and actions may be stored in a machine learning (ML) model that is shared among client devices. The ML model may be a periodically updated set of data that is shared among client devices to ensure the most updated and available information is discoverable by all such client devices and may be used to optimize their data usage and channel assignments in an automated and cohesive manner. In one example, a client device may access a remote server identified by a name, IP address and other information, a type of data service may be used by a particular application for particular period of time. When another client device is going to undergo a similar experience by using the same or a similar application for a same or similar remote server, a decision may be made to bond data channels, receive additional channels from sharing devices or to perform one or more other data optimization operations based on data in the ML model. The content of the ML model that is shared may be a list or table of data elements which is updated and categorized by data packet types, and other parameters.

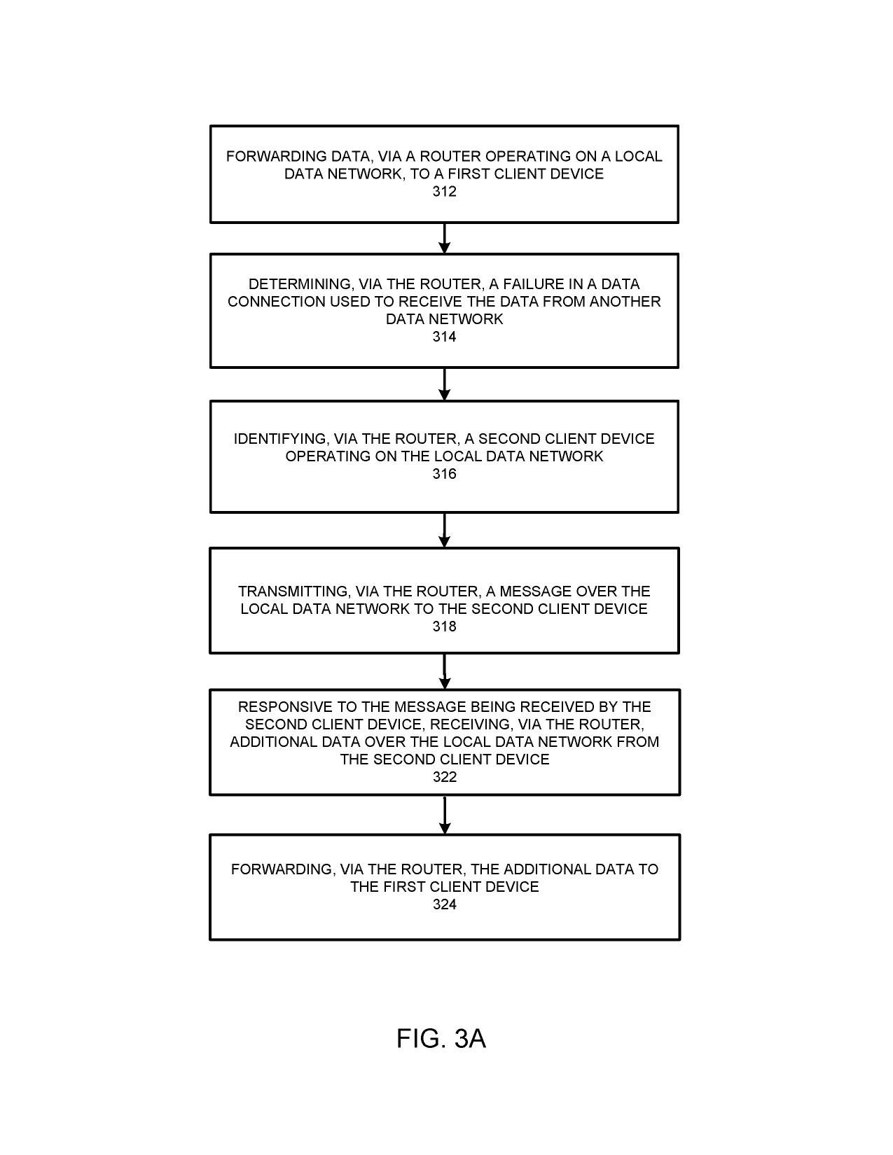

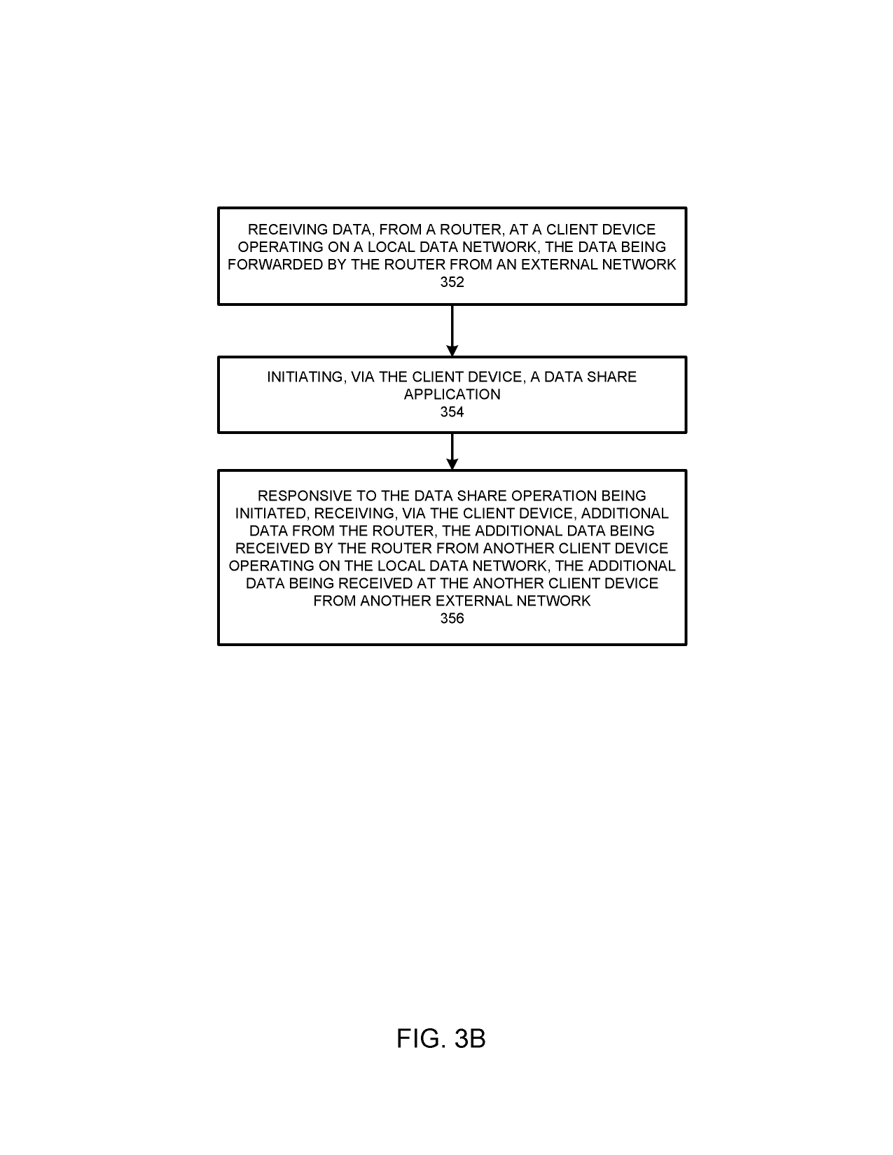

FIG. 3A is a process according to example embodiments. Referring to FIG. 3A, the process may include forwarding data, via a router operating on a local data network, to a first client device 312, determining, via the router, a failure in a data connection used to receive the data from another data network 314, identifying, via the router, a second client device operating on the local data network 316, transmitting, via the router, a message over the local data network to the second client device 318, responsive to the message being received by the second client device, receiving, via the router, additional data over the local data network from the second client device 322, and forwarding, via the router, the additional data to the first client device 324. The second client device may be registered to share data with other client devices based on an established setting or an enabled share option that is stored in one or more of the client devices and/or the router client application 222.

According to other examples, additional data may be provided to the first client device using a direct wireless communication protocol between the first client device and the second client device. The additional data may also be sent to the router and provided to the mobile device to provide a data service between the first client device and the second client device. The additional data is received by a cellular connection associated with the second client device. The process may also include determining, via the router, a change in a data rate associated with the data connection, and determining, via the router, additional client devices operating on the local data network, and transmitting, via the router, a request to each of the additional client devices to enable data sharing. The change may be a drop in a data rate that is available to provide to the first client device and so action should be taken to identify additional data sources.

The process may also include identifying, via the router, another change in the data rate associated with the data connection, providing, via the router, simultaneously the additional data to the first mobile device and the data associated with the data connection, and a data rate associated with the data connection is a lower data rate than a previous data rate associated with the data connection. The process may also include determining, the data rate associated with the connection is above or equal to the previous data rate, and providing, via the router, the additional data to the first mobile device via the data connection. Each time a data rate drop is detected, a channel and/or additional data sources may be identified to increase the data rate. Each time a data rate exceeds an expected data rate target, one or more data sources may be removed from use as the data rate is already optimal.

One example process may include communicating, via a mobile device, with one or more of a Wi-Fi network and a cellular network, identifying, via the mobile device, another mobile device operating on another Wi-Fi network different from the Wi-Fi network, transmitting, via the mobile device, a request for data to the another mobile device and responsive to the request being approved by the another mobile device, receiving, via the mobile device, data from one or more of the Wi-Fi network, the cellular network and/or directly from the another mobile device.

The data received may be forwarded from a virtual private network (VPN) server to the Wi-Fi network, the cellular network and the another Wi-Fi network. The process may also include bonding, via the VPN server, a channel from the Wi-Fi network with a channel from the cellular network and a channel from the another Wi-Fi network, and transmitting, via the VPN server, a stream of packets received from a remote server over the channel from the Wi-Fi network the channel from the cellular network and the channel from the another Wi-Fi network as a bonded connection, and the stream of packets identify the mobile device as the intended recipient.

The sharing of data may include an analysis of the types and number of data channels available to a particular device. For example, the router and/or a device on the network may determine which devices have cellular data in addition to the available Wi-Fi data provided from the ISP. When a device inquires about additional data sources via an automated request sent responsive to a trigger (e.g., large data usage in progress, etc.), the router 220 may be able to identify a candidate device that is capable of sharing data, such as its own Wi-Fi data and/or cellular data. The data may be received by the router directly from the ISP and/or from the device willing to share data, such as from a cellular connection. The data is then routed to the device receiving the benefit of the shared data as a bonded channel or separately in another channel. A VPN server may be instructing the router 220 how to distribute the data, which may include encapsulating the data packets to include the final destination address information of the device receiving the shared data. The router 220 may be a VPN client and may create a VPN tunnel to the Internet that connects to the VPN server. The router 220 can provide connections from the other devices on the Wi-Fi network and send all the data to one device, such as device 142 which is receiving the shared data.

In one example, the router 220 may forward received data from the Internet, forward received data from a mobile device (e.g., cellular data), perform channel bonding by setting up two or more channels to transmit and receive data together, organizing packets, consuming available data, encrypting, unencrypting, encapsulating packets, etc. For example, data packets received at the router 220 from a remote streaming server may be partially received via an Internet connection associated with the router ISP, partially received from a cellular download at a mobile device, which is then forwarded to the router 220 to create a bonding data stream sent from the router 220 to the intended end point mobile device. The router 220 can encapsulate, encrypt and bond the packets in a data stream for delivery to the recipient mobile device. Unlike traditional Wi-Fi routers, which tend to act as endpoints for packet forwarding, the router 220 may be receiving data from devices on its network which also act as endpoints.

In one example, if the device B 144 is receiving data from a sharing device A 142, then the data stream received at device B 144 may include data sent to the router 220 from device 142, such as cellular data received at device 142 and forwarded to the router 220, data from the Internet and forwarded from a VPN server received at router. The data stream sent to device 144 may be a bonded data session of more than one bonded channel. A VPN client installed on the router 220 enables the data management services of a VPN server to be handled by the router for more efficient data sharing efforts performed on a smaller or local area network (LAN).

Another process may include communicating, via a mobile device, with a data network or one or more of a Wi-Fi network and a cellular network, identifying, via the mobile device, another mobile device operating on another data network and/or a Wi-Fi network different from the Wi-Fi network, transmitting, via the mobile device, a request for data to the another mobile device, and responsive to the request being approved by the another mobile device, receiving, via the mobile device, data from the another Wi-Fi network directly from the another mobile device.

The data received may be forwarded from a virtual private network (VPN) server to the another Wi-Fi network. The process may also include bonding, via the VPN server, a channel from the Wi-Fi network with a channel from the cellular network and a channel from the another Wi-Fi network, and transmitting, via the VPN server, a stream of packets received from a remote server over the channel from the Wi-Fi network, the channel from the cellular network and the channel from the another Wi-Fi network as a bonded connection, wherein the stream of packets identify the mobile device as the intended recipient.

The process may also include responsive to receiving confirmation the request was approved, forwarding, via the mobile device, an IP address identifying a virtual private network (VPN) server to the another mobile device, receiving, via the mobile device, first data from a bonded data session comprising a channel from the cellular network and a channel from the Wi-Fi network, and after the request for data is approved, receiving, via the mobile device, second data from another bonded session comprising the channel from the cellular network, the channel from the Wi-Fi network and one or more channels provided by the another mobile device.

Another process may include communicating, via a mobile device, with one or more of a router of a Wi-Fi network and a cellular network, identifying, via the mobile device, another mobile device operating on the Wi-Fi network, transmitting, via the mobile device, a request for data to the another mobile device, and the request is transmitted to the router, and responsive to the request being approved by the another mobile device, receiving, via the mobile device, data from the another mobile device.

The data received may be forwarded from the router. The router may receive the data from a virtual private network (VPN) server. The data may be provided from the cellular network. The process may also include identifying a strength of a signal between the mobile device and the router is below a threshold signal strength, receiving, via the mobile device, the data directly from the another mobile device. The router is operating a virtual private network (VPN) client application that causes the data to be received at the router from a VPN server. The process may also include bonding a channel of the Wi-Fi network with a channel of the cellular network and another channel provided by the another mobile device, and providing the data to the mobile device via the bonded channel.

FIG. 3B is a process of a client device initiating a data sharing operation with other available client devices according to example embodiments. Referring to FIG. 3B, the process may include receiving data, from a router, at a client device operating on a local data network, the data being forwarded by the router from an external network 352. The data may include packets associated with a remote server which were requested by the client device by an active application use operation, a website request, etc. The data may be packets as part of a larger data stream. The process may also include initiating, via the client device, a data share application 354 that enables the client device to send and/or receive data to the router and/or other client devices operating on the network. When the application is initiated, all devices which are also using a similar or the same application may become discoverable and may add the client device to their network of shared devices which can offer shared data and receive data shared. The data shared may be based on cellular data that is received and transmitted by each device and/or another Wi-Fi network other than the network providing data to the devices via the router and its connection to an ISP. The process may also include responsive to the data share operation being initiated, receiving, via the client device, additional data from the router, the additional data being received by the router from another client device operating on the local data network, the additional data being received at the another client device from another external network 356. The router may not be able to provide data from the ISP and may switch to another data source, such as data from another client device which has access to another network, such as a cellular network and may share that data with the client device so the client device may be able to consume the data from the another client device and its own cellular network if available.

In this example, the external network may be an Internet service provider (ISP) network which forwards data to the router. The initiating of the data share application may include an option on the user interface of the client device to turn on data sharing and perform identifying of all client devices in proximity which have enabled data sharing by a same or similar application. The process may also include determining whether the client device has enabled a data receiving option to receive shared data as well as forward data to another device. An option to share data may be for data sharing only and not for receiving shared data. Another option may enable receiving shared data. The process may also include detecting data communication degradation has occurred from the ISP network, such as jitter, latency, packet loss, a drop in bandwidth, data rates, etc., and initiating a data share between the another client device and the client device responsive to the detected data degradation. The sharing may be invoked when the network communication errors are identified as a way to compensate for losses with data from the ISP. The process may also include transmitting, via the client device, a data sharing instruction to the router destined for the another client device and responsive to the another client device receiving the data sharing instruction, receiving the additional data at the client device, and the additional data is received at the another client device from a cellular data network. The cellular data sharing provided by one device to another may not be invoked until the requesting device turns on the data sharing function of an application, the requesting device sends a request to the router that is destined for the other client device(s) on the same network, data degradation has occurred, or a combination of all such circumstances.

The process may also include responsive to determining the ISP network is no longer experiencing data communication degradation, receiving, at the client device, the data from the ISP network bonded with the additional data from the another client device as a single bonded communication stream and the single bonded data stream may include unique packets being received from the ISP network on a first channel and being received from the additional network on a second channel as part of a same bonded data stream.

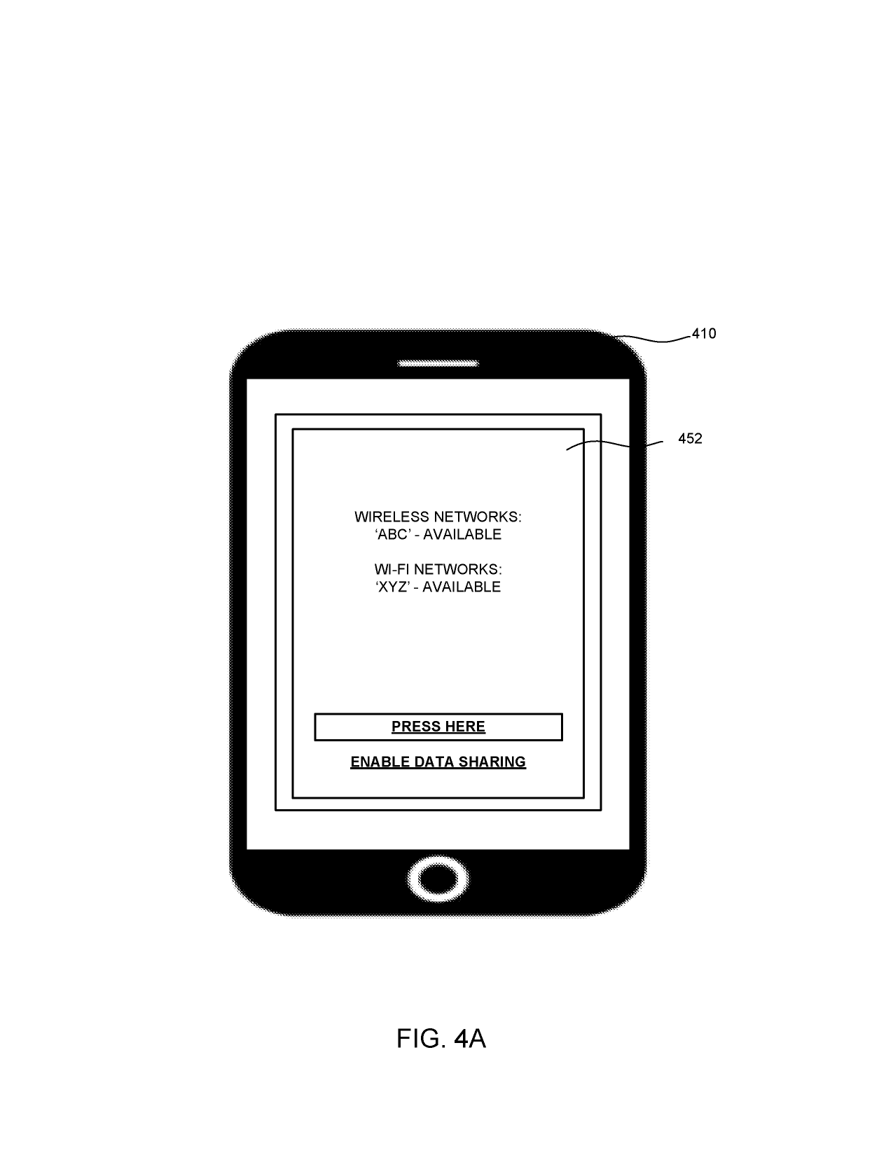

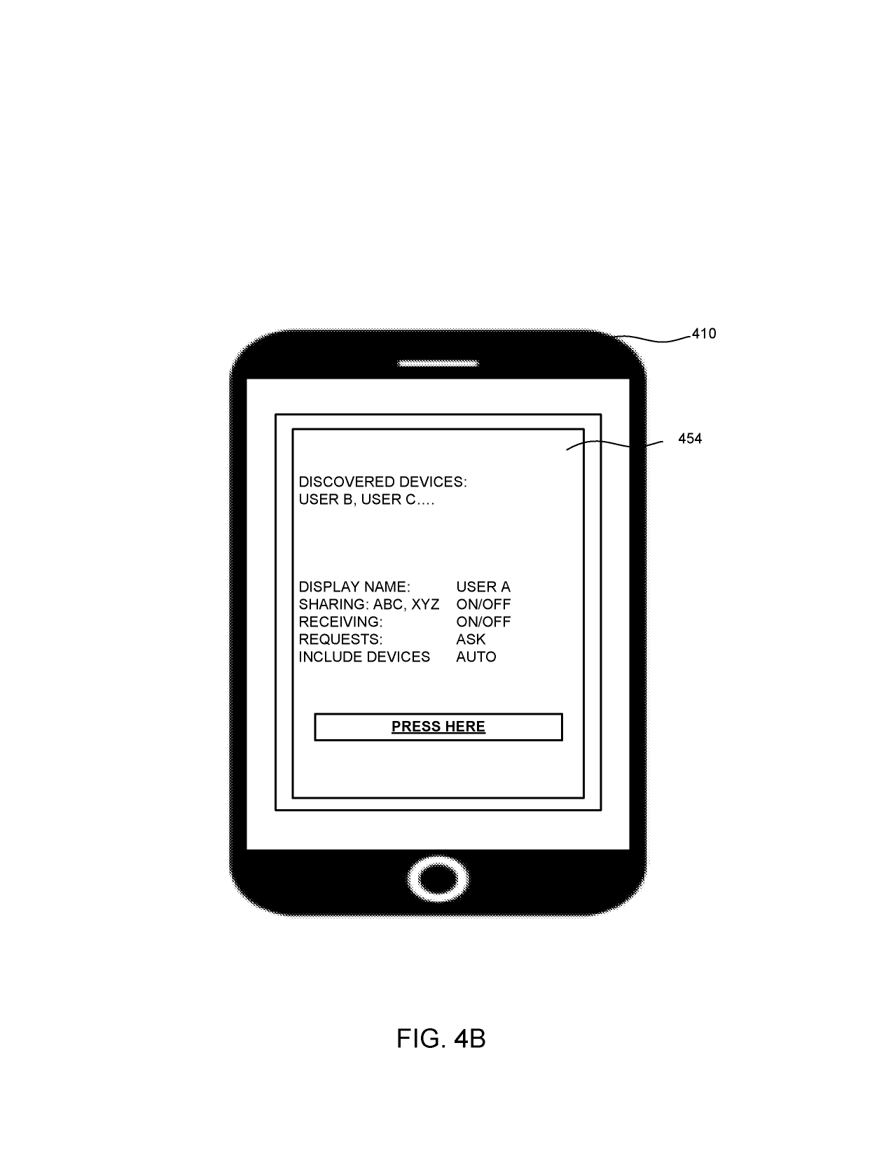

FIG. 4A illustrates an example user interface of a client device initiating a data sharing operation with other devices available on a common network according to example embodiments. Referring to FIG. 4A, the user device 410 may display a first data sharing interface example with the available data networks 452 including all identified wireless (cellular) networks, such as ‘ABC’ and any other networks identifiable. Also, any Wi-Fi networks, such as ‘XYZ’ may also be identified and listed. The option to enable the data sharing may be a simple button.

FIG. 4B illustrates an example user interface of a client device customizing a data sharing application with other devices available on a common network according to example embodiments. Referring to FIG. 4B, the options for data sharing 454 may also include a list of discovered devices which are also on the same network and which may be candidates for data sharing. The client device may have a specific display name, the networks which are desired to be included may be selected or deselected, the option to receive data from another device may be enabled or disabled, the default option for managing requests from other devices to share data may be automated to enable the sharing or may be manually selected.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

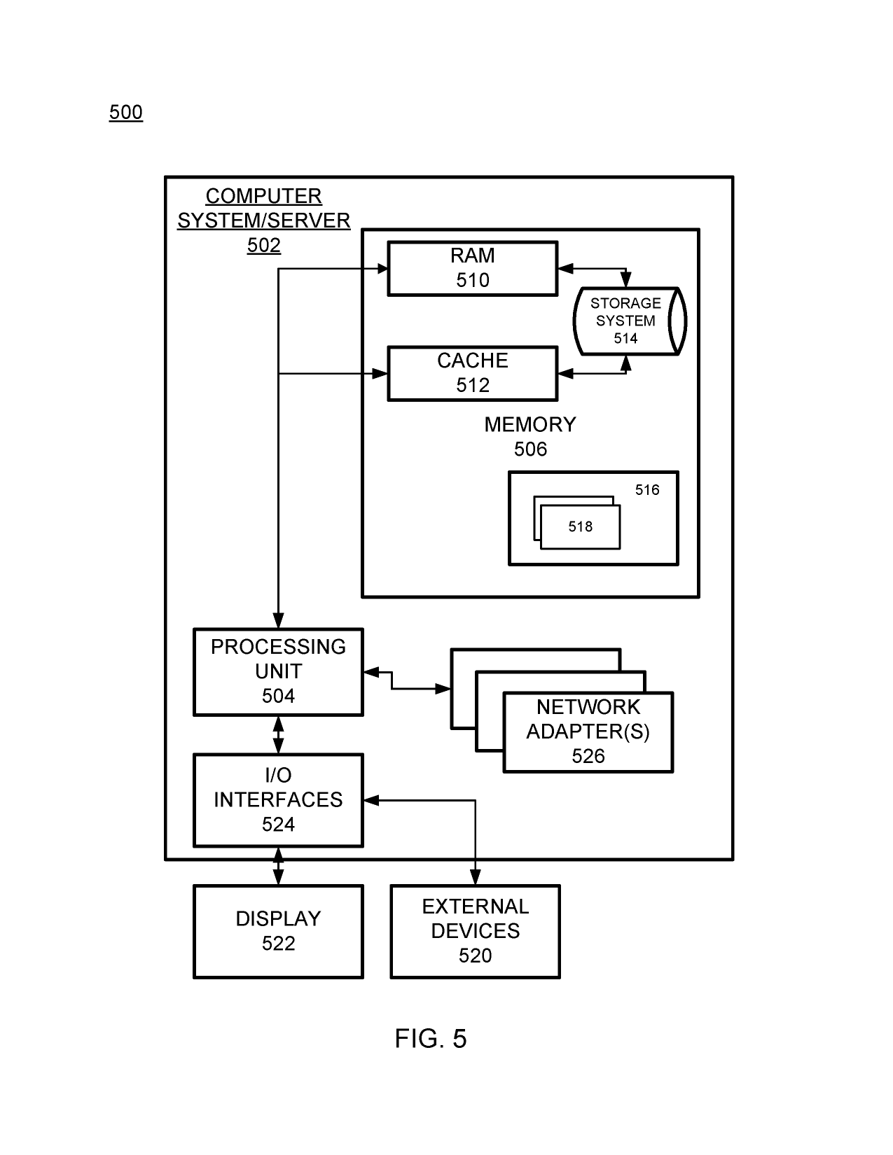

FIG. 5 illustrates an example network entity device configured to store instructions, software, and corresponding hardware for executing the same according to example embodiments. FIG. 5 is not intended to suggest any limitation as to the scope of use or functionality of embodiments of the application described herein. Regardless, the computing node 500 is capable of being implemented and/or performing any of the functionality set forth hereinabove.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 5, computer system/server 502 in cloud computing node 500 is displayed in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 510 and/or cache memory 512. Computer system/server 502 may further include other removable/non-removable, volatile/non-volatile computer system storage media. By way of example only, storage system 514 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility 516, having a set (at least one) of program modules 518, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules 518 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices 520 such as a keyboard, a pointing device, a display 522, etc.; one or more devices that enable a user to interact with computer system/server 502; and/or any devices (e.g., network card, modem, etc.) that enable computer system/server 502 to communicate with one or more other computing devices. Such communication can occur via I/O interfaces 524. Still yet, computer system/server 502 can communicate with one or more networks such as a local area network (LAN), a general wide area network (WAN), and/or a public network (e.g., the Internet) via network adapter(s) 526. As depicted, network adapter(s) 526 communicates with the other components of computer system/server 502 via a bus. It should be understood that although not displayed, other hardware and/or software components could be used in conjunction with computer system/server 502. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
forwarding data, via a router operating on a local data network, to a first client device;
determining, via the router, a failure in a data connection used to receive the data from another data network;
identifying, via the router, a second client device operating on the local data network;
transmitting, via the router, a message over the local data network to the second client device;
responsive to the message being received by the second client device, receiving, via the router, additional data over the local data network from the second client device; and
forwarding, via the router, the additional data to the first client device.

2. The method of claim 1, wherein the additional data is provided to the first client device using a direct wireless communication protocol between the first client device and the second client device.

3. The method of claim 1, wherein the additional data is sent to the router and provided to the mobile device to provide a data service between the first client device and the second client device.

4. The method of claim 1, wherein the additional data is provided by a cellular connection associated with the second client device.

5. The method of claim 1, comprising
determining, via the router, a change in a data rate associated with the data connection; and
determining, via the router, additional client devices operating on the local data network; and
transmitting, via the router, a request to each of the additional client devices to enable data sharing.

6. The method of claim 5, comprising
providing, via the router, the data associated with the data connection and additional data received from the additional client devices to the first mobile device responsive to the change in the data rate.

7. The method of claim 6, comprising
determining, the data rate associated with the connection is above or equal to a previous data rate; and
determining whether to provide, via the router, any additional data to the first mobile device via the data connection based on the data rate being below the previous data rate.

8. A router comprising:
a transmitter configured to forward data to a first client device;
a processor configured to
determine a failure in a data connection used to receive the data from another data network;
identify a second client device operating on the local data network;
send a message over the local data network to the second client device;
responsive to the message being received by the second client device, receive additional data over the local data network from the second client device; and
wherein the transmitter is configured to forward the additional data to the first client device.

9. The router of claim 8, wherein the additional data is provided to the first client device using a direct wireless communication protocol between the first client device and the second client device.

10. The router of claim 8, wherein the additional data is sent to the router and provided to the mobile device to provide a data service between the first client device and the second client device.

11. The router of claim 8, wherein the additional data is provided by a cellular connection associated with the second client device.

12. The router of claim 8, wherein the processor is further configured to
determine a change in a data rate associated with the data connection;
determine additional client devices operating on the local data network; and
wherein the transmitter is configured to transmit a request to each of the additional client devices to enable data sharing.

13. The router of claim 12, wherein the processor is configured to provide the data associated with the data connection and additional data received from the additional client devices to the first mobile device responsive to the change in the data rate.

14. The router of claim 13, wherein the processor is further configured to
determine, the data rate associated with the connection is above or equal to a previous data rate; and
determine whether to provide, via the router, any additional data to the first mobile device via the data connection based on the data rate being below the previous data rate.

15. A non-transitory computer readable storage medium configured to store instructions that when executed cause a processor to perform:
forwarding data, via a router operating on a local data network, to a first client device;
determining, via the router, a failure in a data connection used to receive the data from another data network;
identifying, via the router, a second client device operating on the local data network;
transmitting, via the router, a message over the local data network to the second client device;
responsive to the message being received by the second client device, receiving, via the router, additional data over the local data network from the second client device; and
forwarding, via the router, the additional data to the first client device.

16. The non-transitory computer readable storage medium of claim 15, wherein the additional data is provided to the first client device using a direct wireless communication protocol between the first client device and the second client device.

17. The non-transitory computer readable storage medium of claim 15, wherein the additional data is sent to the router and provided to the mobile device to provide a data service between the first client device and the second client device.

18. The non-transitory computer readable storage medium of claim 15, wherein the additional data is provided by a cellular connection associated with the second client device.

19. The non-transitory computer readable storage medium of claim 15, wherein the processor is further configured to perform:
determining, via the router, a change in a data rate associated with the data connection;
determining, via the router, additional client devices operating on the local data network; and
transmitting, via the router, a request to each of the additional client devices to enable data sharing.

20. The non-transitory computer readable storage medium of claim 19, wherein the processor is configured to perform:
providing, via the router, the data associated with the data connection and additional data received from the additional client devices to the first mobile device responsive to the change in the data rate.
